(19) United States
(12) Patent Application Publication
(10) Pub. No.: US 2005/0241214 A1
(43) Pub. Date: Nov. 3, 2005

(54) Fish hook

(76) Inventor: Patrick J. Ferguson, Portland, OR (US)

Correspondence Address: GLENN C. BROWN, PC, 777 NW WALL STREET, SUITE 308, BEND, OR, 97701, US

(21) Appl. No.: 11/055,838

(22) Filed: Feb. 10, 2005

Related U.S. Application Data
(60) Provisional application No. 60/567,412, filed on Apr. 29, 2004.

(51) Int. Cl. A01K 83/00

(52) U.S. Cl. 43/43.16

(57) ABSTRACT

A fish hook with a point that comprises three or four facets is described herein. The point of the hook is sharp and sturdy and can penetrate easily. The fish hook may also have a dual-angle point.

### CROSS-REFERENCES

This application is a Continuation under 35 U.S.C. § 119 from U.S. Provisional Patent Application Ser. No. 60/567,412, filed Apr. 29, 2004.

### BACKGROUND OF THE INVENTION

Of the many fishing techniques available, line and hook fishing has survived for centuries as one of the most popular and efficient means for catching fish. Today, there are thousands of different fish hooks on the market. One of the most important aspects of a fish hook is the point. The point of the fish hook should puncture the fish's mouth with as little force as possible being used. The point profile influences penetration.

Typically, fish hooks have a point with two facets or a “needle point” that has a conical shape. There are many methods known in the art for forming the point, including chemical sharpening, polishing, grinding and forging.

### BRIEF SUMMARY OF THE INVENTION

One of the objects of the invention is to provide a fish hook that has a point that is very sharp, sturdy and can puncture easily.

In accordance with this object of the invention, a fish hook is provided with three or four facets. In an alternate embodiment, a fish hook is provided that has a dual-angle point. The dual-angle point can have three or four facets.

### BRIEF DESCRIPTION OF THE DRAWINGS

The nature, principle and utility of the present invention will be clearly understood from the following detailed description when read in conjunction with the accompanying drawings, wherein:

FIG. 1 is a view of a three facet fish hook blank.

FIG. 2 is a perspective view along line I-I′ in FIG. 1.

FIG. 3 is a cross-sectional view along line II-II′ in FIG. 1.

FIG. 4 is a view of a four facet fish hook blank.

FIG. 5 is a perspective view along line III-III′ in FIG. 4.

FIG. 6 is a cross-sectional view along line IV-IV′ in FIG. 4.

FIG. 7 is a view of a dual angle fish hook blank.

FIG. 8 is a perspective view along line V-V′ in FIG. 7.

The drawings are for illustrative purposes only and are not drawn to scale. In the drawings, the same numbers are used for the same part or portion throughout the drawings.

### DETAILED DESCRIPTION OF THE INVENTION

A “fish hook blank” is a straight piece of metal, wire or other rigid material that has been formed with a point on one end. The fish hook blank is bent into any desired hook shape to form a fish hook.

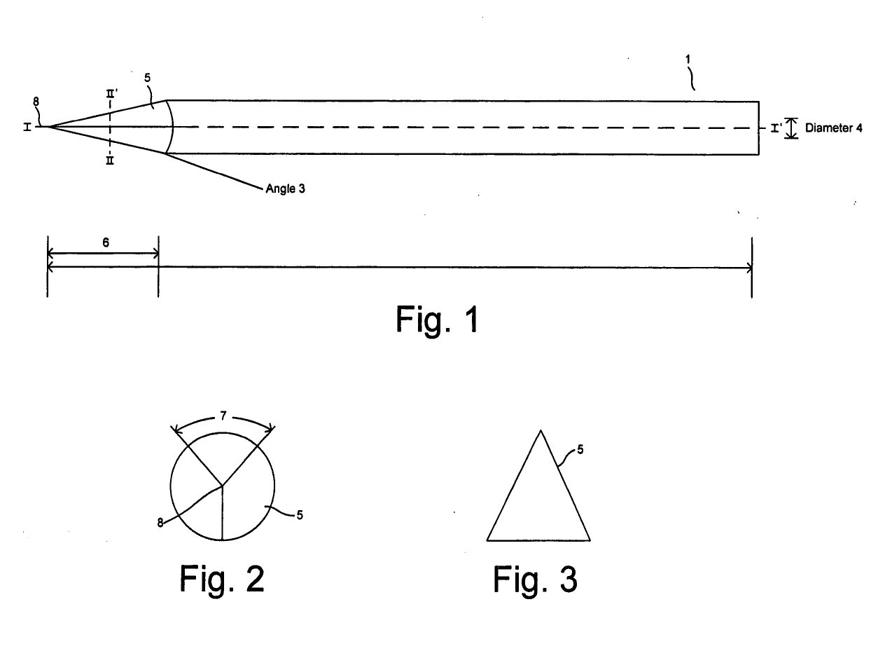

Referring to FIGS. 1-3, a fish hook blank 1 that has a point with three facets is shown. The fish hook blank 1 has a length 2, while the point itself has a length 6. The length 6 of the point is preferably five times the diameter 4 of the fish hook blank 1. The angle 3 of the facets 5 of the point is preferably between 7 and 13 degrees, most preferably 10 degrees. Preferably, the point is formed by grinding.

FIG. 2 is a perspective view along line I-I′ in FIG. 1. FIG. 2 shows that the tip 8 of the point is the convergence of the three facets 5. FIG. 2 also shows that the three facets 5 are formed at an angle 7 relative to each other. The angle 7 is preferably between 117 and 123 degrees and is most preferably about 120 degrees.

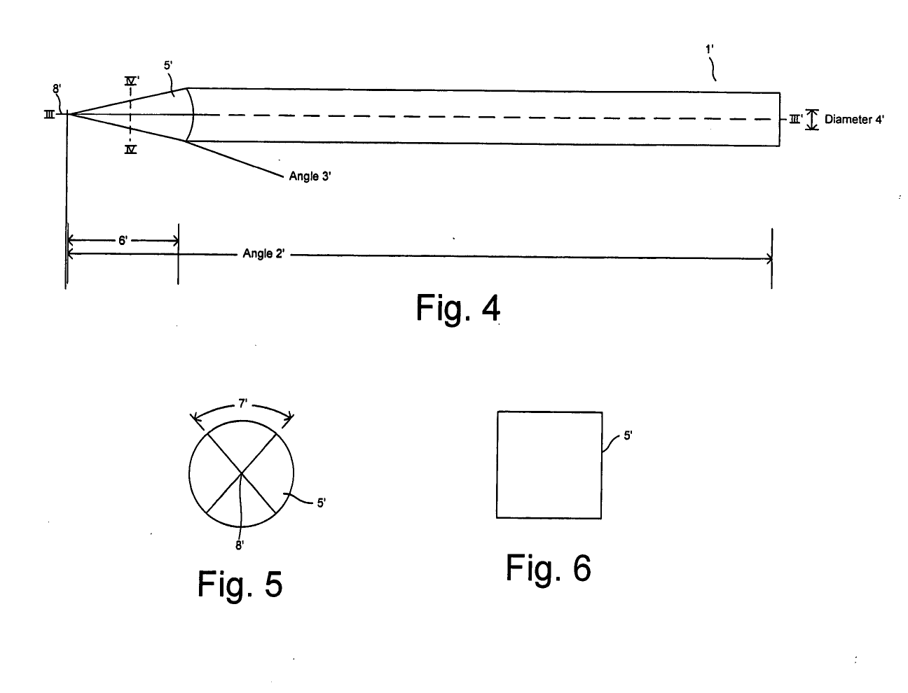

FIG. 3 is a cross-sectional view of FIG. 1 along line II-II′. FIG. 3 shows that the three facets 5 form a triangle at a cross section of the point of the fish hook blank 1. FIGS. 4-6 illustrate a fish hook blank 1′ that has a point with four facets. The fish hook blank 1′ has a length 2′, while the point itself has a length 6′. The length 6′ of the point is preferably five times the diameter 4′ of the fish hook blank 1′. The angle 3′ of the facets 5′ of the point is preferably between 7 and 13 degrees, most preferably 10 degrees. Preferably, the point is formed by grinding.

FIG. 5 is a perspective view along line III-III′ in FIG. 4. FIG. 5 shows that the tip 8′ of the point is the convergence of the four facets 5′. FIG. 5 also shows that the four facets 5′ are formed an angle 7′ relative to each other. The angle 7′ is preferably between 87 and 93 degrees and is most preferably about 90 degrees.

FIG. 6 is a cross-sectional view of FIG. 4 along line IV-IV′. FIG. 6 shows that the four facets 5′ form a square at a cross section of the point of the fish hook blank 1′. Alternatively, the four facets 5′ could form a rectangle.

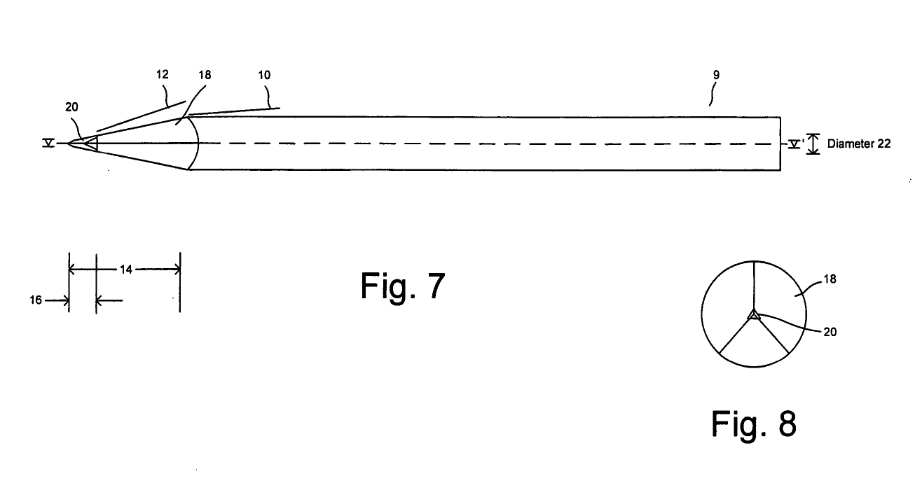

FIGS. 7 and 8 illustrate a fish hook blank 9 that has a point with two different angles. The first angle 10 at which the first facets 18 are formed is about 6 degrees. The second angle 12 at which the second facets 20 are formed is about 12 degrees. The dual-angle fish hook blank 9 can be formed with three or four facets. The example shown in FIGS. 7 and 8 has three facets. The length 16 of the second facets 20 of the point is only a fraction of the length 14 of the entire point. The length 14 of the point is preferably five times the diameter 22 of the fish hook blank 9.

Although the invention has been disclosed in its preferred forms, the specific embodiments thereof as disclosed and illustrated herein are not to be considered in a limiting sense, because numerous variations are possible. The subject matter of the invention includes all novel and non-obvious combinations and subcombinations of the various elements, features, functions, and/or properties disclosed herein.

1. A fish hook, comprising a body and a pointed tip, wherein the pointed tip has four or less facets.

2. The fish hook of claim 1, wherein the pointed tip has three facets.

3. The fish hook of claim 1, wherein a length of the pointed tip is five times a diameter of the body of the fish hook.

4. The fish hook of claim 1, wherein an angle of the facets is between 7 and 13 degrees relative to a central axis of the fish hook body.

5. The fish hook of claim 1, wherein an angle of the facets is 10 degrees relative to a central axis of the fish hook body.

6. The fish hook of claim 2, wherein an angle between two of the facets is between 117 and 123 degrees.

7. The fish hook of claim 2, wherein an angle between two of the facets is 120 degrees.

8. The fish hook of claim 1, wherein the pointed tip has four facets.

9. The fish hook of claim 8, wherein an angle between two of the facets is between 87 and 93 degrees.

10. The fish hook of claim 8, wherein an angle between two of the facets is 90 degrees.

11. The fish hook of claim 1, wherein the pointed tip comprises a first angle relative to a central axis of the fish hook body and a second angle relative to a central axis of the fish hook body.

12. The fish hook of claim 11, wherein the first angle is smaller than the second angle.

13. The fish hook of claim 11, wherein the first angle is 6 degrees relative to a central axis of the fish hook body and the second angle is 12 degrees relative to a central axis of the fish hook body.
